(19) United States
(12) Patent Application Publication
(10) Pub. No.: US 2016/0349415 A1
(43) Pub. Date: Dec. 1, 2016

(54) MULTI-FUNCTION BACKING FILM FOR SILVER MIRRORS

(71) Applicant: E I DU PONT DE NEMOURS AND COMPANY, Wilmington, DE (US)

(72) Inventors: VINCENT RASPAIL, Ferney-Voltaire (FR); JACQUES ROULIN, Vesenaz (CH)

(21) Appl. No.: 15/163,732

(22) Filed: May 25, 2016

Related U.S. Application Data
(60) Provisional application No. 62/166,870, filed on May 27, 2015.

(51) Int. Cl. G02B 5/08; C03C 17/32; C03C 17/06

(52) U.S. Cl. CPC G02B 5/0808; C03C 17/06; C03C 17/328; C03C 2217/256

(57) ABSTRACT

The present invention relates to silver mirrors and to methods for manufacturing such mirrors.

### CROSS-REFERENCE TO RELATED APPLICATIONS

This application claims priority benefit of U.S. Provisional Application No. 62/166,870 filed May 27, 2015, which is incorporated herein in its entirety.

### FIELD OF THE INVENTION

The present invention relates to silver mirrors and to methods for manufacturing such mirrors. In particular, the present invention relates to silver mirrors for use in furnishings and decoration.

### BACKGROUND OF THE INVENTION

Mirrors are traditionally made of a silver layer coated on the back of a glass substrate. The silver coating on the glass substrate forms a reflective surface and the quality of the reflective surface is dependent on the quantity of silver deposited on the glass substrate. The quantity of silver used in conventional silver mirrors is usually higher than or equal to 800 mg/m2. This quantity of silver provide a good compromise between an acceptable reflectivity and an acceptable production cost. Thus, there is a great economical interest to reduce the amount of silver in the silver coating layer or to remove the silver layer while keeping the same reflectivity.

In addition to the silver coating step, several additional treatments and coatings are necessary to protect the silver reflective layer from environmental aging such as UV protection, corrosion protection, oxidation protection etc. Usually, these steps are performed by application onto the silver layer of liquid layers consisting of paints, aqueous dispersion, solvent dispersion and the like. These liquid layers are usually applied in the form of continuous liquid falling onto the silver layer or sprayed directly onto the silver layer. In case of liquid layer in form of paint, an additional step is undertaken to dry it or cure it in an oven.

In case of special needs, in addition to these protection layers, a safety back layer can be added to the mirror to make it shatterproof or to prevent shards of glass to scatter in case the mirror is broken. Usually, such safety back layers are applied as a tape of 120 μm thickness and are made of polyolefin such as polyethylene, reinforced or not with woven fabrics, where the polyolefin can be coated with an adhesive, preferentially a pressure sensitive adhesive. The safety back layer should retain more than 98% of shards of glass when the mirror is impacted. The manufacturing step of applying the safety back layer is labor intensive and requires several cutting and gluing steps which amount to higher production costs.

Therefore, there is a need for a silver mirror and a process to make it that will contain reduced amount of silver in the silver coated layer, that will provide for protection of the silver coated layer and that will be shatterproof while being manufactured or produced in a cost effective way.

### SUMMARY OF THE INVENTION

This aim has been achieved with the mirrors described herein wherein the mirror comprises:

(a) a glass substrate,
(b) a silver coating at said glass substrate,
(c) at least one layer comprising a ionomer resin,
(d) at least one layer comprising a metallized polypropylene film or a metallized polyester film, and
(e) optionally at least one adhesive layer comprising an ethylene acid copolymer resin.

In a preferred embodiment, the mirror comprises in the order recited:

(a) a glass substrate,
(b) a silver coating at said glass substrate,
(c) at least one layer comprising an ionomer resin, and
(d) at least one layer comprising a metallized polypropylene film or a metallized polyester film.

In another embodiment, the mirror according to the present invention comprises in the order recited:

(a) a glass substrate,
(b) a silver coating at said glass substrate,
(c) an adhesive layer comprising an ethylene acid copolymer resin,
(d) a layer comprising an ionomer resin,
(e) an adhesive layer comprising an ethylene acid copolymer resin, and
(f) a layer comprising a metallized polypropylene film or a metallized polyester film.

Optionally, the mirror according to the present invention further comprises an opaque layer provided at the surface of the layer comprising a metallized polypropylene film or a metallized polyester film. Preferably, the opaque layer is provided at the surface of the metallized polypropylene film or a metallized polyester film that is not coated with metal. This opaque layer can be made of any colored polymer, preferable of colored polyethylene for cost reason.

Optionally, the mirror according to the present invention further comprises an adhesive layer comprising an ethylene acid copolymer resin between the layer comprising a metallized polypropylene film or a metallized polyester film and the opaque layer.

In the mirrors of the present invention, the quantity of silver present at the surface of the glass substrate is preferably less than or equal to 500 mg/m². Also preferably, the silver coating, in the mirrors of the present invention, has a thickness less than 100 nm, preferentially less than or equal to 50 nm.

Also disclosed herein is a method to make the mirrors of the present invention and its use thereof.

### DETAILED DESCRIPTION

### Definitions

As used herein, the term “a” refers to one as well as to at least one and is not an article that necessarily limits its referent noun to the singular.

As used herein, the terms “about” and “at or about” are intended to mean that the amount or value in question may be the value designated or some other value about the same. The phrase is intended to convey that similar values promote equivalent results or effects according to the invention.

As used herein, the term “acrylate” means an ester of acrylic acid with an alkyl group. Preferred in the invention are acrylates with alkyl groups having 1 to 4 carbon atoms.

As used herein, the term, the term “(meth)acrylic acid” refers to methacrylic acid and/or acrylic acid, inclusively. Likewise, the term “(meth)acrylate” means methacrylate and/or acrylate and “poly(meth)acrylate” means polymers derived from the polymerization of either or a mixture of both corresponding type of monomers.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 18 weight percent of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such. The term “copolymer” may refer to polymers that consist essentially of copolymerized units of two different monomers (a dipolymer), or that consist essentially of more than two different monomers (a terpolymer consisting essentially of three different comonomers, a tetrapolymer consisting essentially of four different comonomers, etc.).

The term “acid copolymer” refers to a polymer comprising copolymerized units of an α-olefin, an α,β-ethylenically unsaturated carboxylic acid, and optionally other suitable comonomer(s), such as an α,β-ethylenically unsaturated carboxylic acid ester.

The term “ionomer” refers to a polymer that is produced by partially or fully neutralizing an acid copolymer as described above.

The mirrors of the present invention comprise:

(a) a glass substrate,
(b) a silver coating at said glass substrate,
(c) at least one layer comprising an ionomer resin,
(d) at least one layer comprising a metallized polypropylene film or a metallized polyester film, and
(e) optionally at least one adhesive layer comprising an ethylene acid copolymer resin.

The silver coating is deposited onto the glass substrate by usual methods that are known to the person skilled in the art. For instance, silver can be deposited by spray coating, vacuum deposition etc.

Conventionally, silver mirrors have been produced as follows: the glass was first of all polished and then sensitized, typically using an aqueous solution of SnCl₂; after rinsing, the surface of the glass was usually activated by means of an ammoniacal silver nitrate treatment, and a silvering solution was then applied in order to form an opaque coating of silver. The quantity of silver deposited onto the glass is preferably lower than 700 mg/m², more preferably lower than or equal to 500 mg/m². The thickness of the silver coating is preferably lower than 100 nm, more preferably lower than or equal to 50 nm. In order to provide for UV protection, corrosion protection, oxidation protection and any chemical protection to the silver coating, the mirrors of the present invention comprise at least one layer comprising an ionomer resin. As an alternative to ionomer, a polyethylene, a polybut 1-ene, a metallocene polyethylene or polyvinyl butacite resins could be used. However, ionomers are preferred since in addition to the protection conferred to the silver coating, the ionomer layer renders the mirrors shatterproof and then the ionomer layer functions as safety glass layer. In addition, it is preferred to use ionomers that can provide transparent layers in order to preserve the reflectivity of the layer comprising a metallized polypropylene film or a metallized polyester film.

The thickness of the layer comprising the ionomer resin is preferably from 20 to 100 μm, more preferably from 30 to 70 μm, even more preferably 70 μm.

The ionomer of the present invention is a polymer that is produced by partially or fully neutralizing an acid copolymer, such as ethylene acid copolymers, as described below.

Suitable ethylene acid copolymers and ionomers are described in U.S. Pat. No. 7,641,965, issued to Bennison et al., for example. Briefly, however, the ethylene acid copolymer comprises copolymerized units of an α-olefin having from 2 to 10 carbon atoms and about 8 to about 30 weight percent, preferably about 15 to about 30 weight percent, more preferably about 20 to about 30 weight percent, yet more preferably about 20 to about 25 weight percent, or still more preferably about 21 to about 23 weight percent of copolymerized units of an α,β-ethylenically unsaturated carboxylic acid having 3 to 8 carbon atoms. The weight percentage is based on the total weight of the ethylene acid copolymer. Preferably, the α-olefin comprises ethylene; more preferably, the α-olefin consists essentially of ethylene. Also preferably, the α,β-ethylenically unsaturated carboxylic acid comprises acrylic acid, methacrylic acid, or a combination of acrylic acid and methacrylic acid. More preferably, the α,β-ethylenically unsaturated carboxylic acid consists essentially of acrylic acid, methacrylic acid, or a combination of acrylic acid and methacrylic acid.

The ethylene acid copolymers may further comprise copolymerized units of other comonomer(s), such as unsaturated carboxylic acids having 2 to 10, or preferably 3 to 8 carbon atoms or derivatives thereof. Suitable acid derivatives include acid anhydrides, amides, and esters. Esters are preferred derivatives. Preferably the esters are α,β-ethylenically unsaturated carboxylic acid ester comonomers and include, but are not limited to, methyl acrylate, ethyl acrylate, isopropyl acrylate, butyl acrylate and combinations thereof.

The ethylene acid copolymers may be synthesized by any suitable polymerization process. For example, the ethylene acid copolymers may be polymerized as described in U.S. Pat. Nos. 3,404,134; 5,028,674; 6,500,888; and 6,518,365.

Preferably, the ethylene acid copolymer has a melt index (MI) of about 60 g/10 min or less, more preferably about 45 g/10 min or less, yet more preferably about 30 g/10 min or less, or yet more preferably about 25 g/10 min or less, or still more preferably about 10 g/10 min or less, as measured by ASTM method D1238 at 190° C. and 2.16 kg.

Some suitable ethylene acid copolymer resins are commercially available from E.I. du Pont de Nemours and Company of Wilmington, Del. (“DuPont”), under the trademark Nucrel®.

To obtain the ionomers, at least a portion of the carboxylic acid moieties of the ethylene acid copolymers is neutralized to form carboxylate groups. Preferably about 5 to about 90%, more preferably about 10 to about 50%, yet more preferably about 20 to about 50%, or still more preferably about 20 to about 35% of the carboxylic acid groups are neutralized, based on the total carboxylic acid content of the ethylene acid copolymers. An example of a suitable procedure for neutralizing the ethylene acid copolymers is also described in U.S. Pat. No. 3,404,134.

The ionomers comprise cations as counterions to the carboxylate anions. Suitable cations include any positively charged species that is stable under the conditions in which the ionomer composition is synthesized, processed and used. Preferably, the cations are metal cations that may be monovalent, divalent, trivalent or multivalent. Combinations of two or more cations that may have different valencies, for example mixtures of Na+ and Zn2+ or mixtures of NH4+ and K+, are also suitable. The cations are more preferably monovalent or divalent metal ions. Still more preferably, the metal ions are selected from the group consisting of ions of sodium, lithium, magnesium, zinc, and potassium and combinations of two or more thereof. Still more preferably, the metal ions are selected from the group consisting of ions of sodium, ions of zinc and combinations thereof. Still more preferably, the metal ions comprise or consist essentially of sodium ions.

The ionomer preferably has a MI of about 13 g/10 min or less, more preferably about 5 g/10 min or less, or still more preferably about 3 g/10 min or less, about 1.0 g/10 min or less, about 0.5 g/10 min or less, about 0.2 g/10 min or less, or about 0.1 g/10 min or less, as measured by ASTM method D1238 at 190° C. and 2.16 kg. The ionomer also preferably has a flexural modulus greater than about 40,000 psi (276 MPa), more preferably greater than about 50,000 psi (345 MPa), or still more preferably greater than about 60,000 psi (414 MPa), as measured by ASTM method D790 (Procedure A).

Some suitable ionomeric resins are commercially available from DuPont, under the trademarks Surlyn® resins.

The mirrors of the present invention also comprise a layer comprising a metallized polypropylene film or a metallized polyester film. The thickness of the layer comprising a metallized polypropylene film or a metallized polyester film is preferably from 5 to 100 μm, preferably from 10 to 50 μm. Such thickness for a layer comprising a metallized polypropylene film or a metallized polyester film has the advantage of ensuring that the properties of reflection and opacity sought for the mirrors of the present invention are met.

Metallized polypropylene films are film of polypropylene resin, usually between 10 microns and 50 microns coated with a thin layer of metal usually aluminum. Metallized polyester films are films usually between 10 microns and 50 microns coated with a thin layer of metal usually aluminum. The aluminum coating is usually done by vapor deposition on one surface of the film although it would be possible to coat both surfaces. These types of films are widely available for the food packaging industry for protection or decorative purpose. Other type of resin are also available such as Nylon and Polyethylene. Upon request it is possible to metallize colored previously named films.

Suitable metallized polypropylene films or metallized polyester films are available under the tradename Metallyte® from ExxonMobil or Mylar® 800 MO/ MI from DuPont Teijin Film. Alternatively the metallized films could be replaced by an aluminum film.

In one embodiment, the mirror of the present invention comprises in the order recited:

(a) a glass substrate,
(b) a silver coating at said glass substrate,
(c) at least one layer comprising an ionomer resin,
(d) at least one layer comprising a metallized polypropylene film or a metallized polyester film. The metallized films may be colored if desired.

Optionally, the mirrors of the present invention may further comprise one or more adhesive layers in order to make the different layers or coatings, that are constituting the mirrors, adhere to each other. When used, the adhesive layer comprises an ethylene acid copolymer resin as described above. As an alternative to the adhesive layer of the present invention, the layers could be glued to each other. However, the adhesive layer comprising an ethylene acid copolymer resin is preferred.

The thickness of the adhesive layer comprising the ethylene acid copolymer resin is preferably from 5 to 50 μm, more preferably from 10 to 30 μm, even more preferably 20 μm.

In one preferred embodiment, the mirrors according to the present invention comprise in the order recited:

(a) a glass substrate,
(b) a silver coating at said glass substrate,
(c) an adhesive layer comprising an ethylene acid copolymer resin,
(d) a layer comprising an ionomer resin,
(e) an adhesive layer comprising an ethylene acid copolymer resin, and
(f) a layer comprising a metallized polypropylene film or a metallized polyester film.

The adhesive layer(s) comprising an ethylene acid copolymer resin and the layer comprising the ionomer resin should be transparent, i.e. the layers should allow light to pass through the material without being scattered. Preferentially, the layers should have a haze lower that 5% measured according to ASTM D-1003-13. When more opacity than the one provided by the silver coating and the layer comprising a metallized polypropylene film or a metallized polyester film is desired, the mirrors of the present invention may further comprise an opaque layer that is provided at the surface of the layer comprising the metallized polypropylene film or the metallized polyester film. Optionally, an adhesive layer, as described above, can be used between the opaque layer and the layer comprising a metallized polypropylene film or a metallized polyester film. The metallized films may be colored or not depending on the application. The opaque layer may be colored or not and the opaque layer may be made of any polyolefin containing carbon black or pigments.

The resins used in the present invention may additionally comprise additives including plasticizers, stabilizers including viscosity stabilizers and hydrolytic stabilizers, primary and secondary antioxidants, ultraviolet ray absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. These additives are described in the Kirk Othmer Encyclopedia of Chemical Technology.

The additives may be incorporated into the resins by any known process such as by dry blending, extruding a mixture of the various constituents, the conventional masterbatch technique, or the like.

The layer comprising the ionomer resin, the metallized polypropylene film or the metallized polyester film and optionally the adhesive layer comprising an ethylene acid copolymer resin can be provided in the form of a multilayer film. Multilayer films are made by conventional methods. The multilayer films of the invention may be prepared by cast film co-extrusion, cast sheet extrusion or blow film coextrusion or by lamination. A preferred method is to prepare the multilayer film comprising the ionomer resin, the metallized polypropylene film or the metallized polyester film and optionally the adhesive layer comprising an ethylene acid copolymer resin by co-extruding the ionomer resin layer and optionally the adhesive layer comprising an ethylene acid copolymer onto a substrate being the metallized polypropylene film or onto a substrate a metallized polyester film.

Multilayer films used in the mirrors of the present invention comprise, at least one layer comprising an ionomer resin and at least one layer comprising a metallized polypropylene film or a metallized polyester film. Optionally, the multilayer film may further comprise at least one adhesive layer comprising an ethylene acid copolymer resin.

In a preferred embodiment, the multilayer film of the present invention comprises in the order recited:

(a) an adhesive layer comprising an ethylene acid copolymer resin,
(b) a layer comprising an ionomer resin,
(c) an adhesive layer comprising an ethylene acid copolymer resin, and
(d) a layer comprising a metallized polypropylene film or a metallized polyester film.

The multilayer films of the present invention may further comprise an opaque layer provided at the surface of the layer comprising a metallized polypropylene film or a metallized polyester film. When the opaque layer is present in the multilayer film, an adhesive layer comprising an ethylene acid copolymer resin may be used between the layer comprising a metallized polypropylene film or a metallized polyester film and the opaque layer.

The multilayer film may be applied by conventional methods including batch method like heat lamination on a press, semi continuous process where the mirror and the film are conveyed under a semi continuous press, and preferably continuous process as belt lamination and calendaring onto the glass substrate coated with silver. Preferably, the multilayer film is applied directly onto the face of the glass substrate which has been coated with silver.

Also provided herein is a method to manufacture the mirrors of the present invention. The method comprises the step of:
(a) providing a glass substrate,
(b) coating silver onto the glass substrate,
(c) providing a multilayer film comprising at least one layer comprising an ionomer resin and a layer comprising a metallized polypropylene film or a metallized polyester film and optionally at least one adhesive layer comprising an ethylene acid copolymer resin, and
(d) applying the multilayer film onto the glass substrate under heat and pressure.

In another embodiment, the method to manufacture the mirrors of the present invention comprises the step of:
(a) providing a glass substrate,
(b) coating silver onto the glass substrate,
(c) providing a first multilayer film including at least one layer comprising an ionomer resin,
(d) providing a second multilayer film comprising a metallized polypropylene film or a metallized polyester film, and
(e) applying the first and second multilayer films onto the glass substrate under heat and pressure.

Heat can be provided by any means known to the person skilled in the art including oven, infra-red, hot roll, etc.

In the method according to the present invention silver is present at the surface of the glass substrate in a quantity lower than or equal to 500 mg/m².

In the method according to the present invention, the silver coating has a thickness of 50 to 100 nm.

In the method according to the present invention, the multilayer films of steps (c) or (d) further comprise an adhesive layer comprising an ethylene acid copolymer resin.

In the method according to the present invention, the multilayer films of steps (c) or (d) further comprise an opaque layer provided at the surface of the layer comprising a metallized polypropylene film or a metallized polyester film.

The mirrors of the present invention can be used in various applications, for example, in furnishings and decoration, domestic mirrors used in furniture, wardrobes or bathrooms; mirrors for make-up boxes, mirrors used in the automotive industry such as rear view mirrors and mirrors used in solar energy reflectors.

### EXAMPLES

The invention is further illustrated by certain embodiments in the examples below which provide greater detail for the compositions, uses and processes described herein. These examples, which set forth a preferred mode presently contemplated for carrying out the invention, are intended to illustrate and not to limit the invention.

The following materials were used to prepare the multilayer films and the silver mirrors described herein.

Metallized polypropylene film (OPP Met): Oriented vaccum metallized polypropylene film of 18 microns thickness commercially available from ExxonMobil under the tradename Mettalyte® 70.
Ethylene acid copolymer resin, Adhesive 1: Copolymer of ethylene and 9.5% of acrylic acid available from E.I. du Pont de Nemours and Company, under the tradename Nucrel® 3990 and having a melt index of 10.

Ethylene acid copolymer resin, Adhesive 2: Copolymer of ethylene and 11.5% of acrylic acid available from E.I. du Pont de Nemours and Company, under the tradename Nucrel® 1202 and having a melt index of 1.5.

Ionomer resin 1: Copolymer of ethylene and of acrylic acid neutralized with zinc from E.I. du Pont de Nemours and Company, under the tradename Surlyn® 1706 and having a melt index of 0.7.

Ionomer resin 2: Copolymer of ethylene and of acrylic acid neutralized with sodium from E.I. du Pont de Nemours and Company under the tradename Surlyn® PC2200 and having a melt index of 13

### Preparation of the Multilayer Film

Each film was produced by 3 layers co-extrusion on a substrate made of metallized polypropylene film (OPP Met) on a line from EGAN. The multilayer film was prepared by introducing the Ethylene acid copolymer resin in the extruder B (2.5″) & C (3″) and the ionomer resin in the extruder A (2,5″). The feedblock was set up in order to achieve the following structure.

OPP Met (Substrate)//Ethylene acid copolymer resin (Adhesive) 15 microns//ionomer resin (Shatterproof resin) 70 microns//Ethylene acid copolymer resin (Adhesive) 15 microns

The following multilayer films were produced:
Film A: OPP met//15 um Adhesive 2/70 um ionomer resin 2/15 um Adhesive 2
Film B: OPP met//15 um Adhesive 1/70 um ionomer resin 1/15 um Adhesive 1

Preparation of Mirror with Multilayer Film

The samples were prepared as follows: square of 200×200 mm of multilayer film were cut. The square were positioned on a mirror with 500 mg/m² of silver in order to cover the whole surface. The structure was pressed on a lab scale press from Colin at 130° C. on the film side for 3 min under 80 bar pressure. To avoid sticking the film to the press, a 12 μm polyester film covered it. The press was then cooled down to 25° C. The mirror including the multiplayer film was removed from the press.

What is claimed is:

1. A mirror comprising:
a glass substrate;
a silver coating at said glass substrate;
at least one layer comprising an ionomer resin;
at least one layer comprising a metallized polypropylene film or a metallized polyester film; and
optionally at least one adhesive layer comprising an ethylene acid copolymer resin.

2. The mirror according to claim 1, wherein the layer comprising the ionomer resin is a single layer, and the layer comprising a metallized polypropylene film or a metallized polyester film is a single layer.

3. The mirror according to claim 1, further comprising an opaque layer provided at the surface of the layer comprising a metallized polypropylene film or a metallized polyester film.

4. The mirror according to claim 3, further comprising an adhesive layer comprising an ethylene acid copolymer resin between the layer comprising a metallized polypropylene film or a metallized polyester film and the opaque layer.

5. The mirror according to claim 4, wherein silver is present at the surface of the glass substrate in a quantity lower than or equal to 500 mg/m².

6. The mirror according to claim 5, wherein the silver coating has a thickness of 50 to 100 nm.

7. The mirror according to claim 6, wherein the layer comprising a ionomer resin has a thickness of 30 to 70 μm, preferably 70 μm.

8. The mirror according to claim 7, wherein the adhesive layer comprising an ethylene acid copolymer resin has a thickness of 5 to 50 μm, preferably 20 μm.

9. The mirror according to claim 8, wherein the layer comprising a metallized polypropylene film or a metallized polyester film has a thickness of 5 to 100 μm, preferably 10 to 50 μm.

10. A method to manufacture a mirror comprising the step of:
(a) providing a glass substrate;
(b) coating silver onto the glass substrate;
(c) providing a multilayer film comprising at least one layer;
comprising an ionomer resin and a layer comprising a metallized polypropylene film or a metallized polyester film and optionally at least one adhesive layer comprising an ethylene acid copolymer resin; and
(d) applying the multilayer film onto the glass substrate under heat and pressure.

11. A method to manufacture a mirror comprising the step of:
(a) providing a glass substrate;
(b) coating silver onto the glass substrate;
(c) providing a first multilayer film including at least one layer comprising an ionomer resin;
(d) providing a second multilayer film comprising a metallized polypropylene film or a metallized polyester film; and
(e) applying the first and second multilayer films onto the glass substrate under heat and pressure.

12. The method according to claim 11, wherein silver is present at the surface of the glass substrate in a quantity lower than or equal to 500 mg/m².

13. The method according to any of the claim 12, wherein the silver coating has a thickness of 50 to 100 nm.

14. The method according to claim 13, wherein the multilayer films of steps (c) or (d) further comprise an adhesive layer comprising an ethylene acid copolymer resin.

15. The method according to claim 14, wherein the multilayer films of steps (c) or (d) further comprise an opaque layer provided at the surface of the layer comprising a metallized polypropylene film or a metallized polyester film.
